(19) United States
(12) Patent Application Publication
(10) Pub. No.: US 2004/0105196 A1
(43) Pub. Date: Jun. 3, 2004

(54) Composite magnetic head

(75) Inventor: Kouji Kataoka, Fujisawa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies Japan, Ltd., Odawara-shi (JP)

(21) Appl. No.: 10/665,917

(22) Filed: Sep. 17, 2003

(30) Foreign Application Priority Data
Nov. 21, 2002 (JP) 2002-337600

(51) Int. Cl. G11B 5/39

(52) U.S. Cl. 360/324.12; 360/322

(57) ABSTRACT

A magnetoresistive film 4, hard magnetic layers 22a and 22b disposed from both ends thereof for stabilizing the magnetoresistive film 4 and main electrode layers 24a, 24b for applying a current for sensing are disposed, the width of the pinning layer 12 is made narrower relative to the width of the free layer 14 in the magnetoresistive film 4 and overlaid electrode layers 21a, 21b are respectively disposed between the main electrode layer 24a and one end of the pinning layer 12 and between the main electrode layer 24b and the other end of the pinning layer 12. Thus, the respective low sensitivity regions near the contact portions respectively located between the hard magnetic layer 22a and one end of the magnetoresistive film 4 and between the hard magnetic layer 22b and the other end of the magnetoresistive film 4 are made into insensitive regions.

### CROSS-REFERENCES TO RELATED APPLICATIONS

This application claims priority to Japanese Application No. 2002-337600, filed Nov. 21, 2002, the disclosure of which is incorporated by reference.

### BACKGROUND OF THE INVENTION

1. Field of the Invention

The present invention relates to a composite magnetic head comprising a reading magnetoresistive head and a recording inductive magnetic head in combination and, more particularly, it relates to a magnetoresistive head capable of stably reading magnetic recording information written in a magnetic recording medium at high sensitivity by using a magnetoresistive effect.

2. Description of Related Art

The bit length and narrowing of the track width on the recording medium has been considered as the most important subject in the magnetic recording apparatus and a demand for a head capable of stably reading magnetic information written on extremely minute tracks at high sensitivity has been increased more and more. A main goal of the magnetic resistive head is to narrow the track, improve the sensitivity and control (stabilize) Barkhausen noises.

For this purpose, a longitudinal bias magnetic field (also referred to as a track-transversal bias magnetic field) to stably operate the magnetoresistive head has to be provided to the magnetoresistive film. The longitudinal bias magnetic field is applied so as to make the magnetoresistive film into a single-magnetic domain, which is sometimes also referred to as a longitudinal bias magnetic field.

To apply the longitudinal bias magnetic field, the magnetoresistive film is patterned into a predetermined shape (formation of track width), and then hard magnetic layers are disposed on both sides thereof for applying the longitudinal bias magnetic field. The hard magnetic layer is in contact with a sensor portion comprising a film having the magnetoresistive effect at the top end region having the same extension as the electrode structure, thereby attaining longitudinal bias by magnetic coupling between the hard magnetic layer and the sensor portion. Accordingly, the sensor portion is magnetized in a specified direction along the patterned longitudinal direction.

The problem involved in the method is that exchanging coupling or static magnetic coupling is extremely increased on both ends of the sensor portion, that is, portions joined with the hard magnetic layer and a low sensitivity region is present in the vicinity thereof in which the sensitivity to the magnetic signal from the recording medium is lowered extremely. In a case of a track width as wide as the low sensitivity region is negligible, a relation that the head output is reduced to one-half when the track width is reduced to one-half is maintained. However, when the low sensitivity region is not negligible to the track width, the sensitivity is lowered by one-half or more relative to one-half of the track width. According to the study made by the present inventors, it has been confirmed that such low sensitivity region is present by about 100 nm as the total of both sides being converted into the width. The track width has been narrowed particularly in recent years, and the reading track width of the head adopted for the magnetic disk apparatus with a recording density per one square inch of about 25 Gb, for example, is 300 nm or less and the width of low sensitivity region has become not negligible along with reduction of the track width.

A structure, for example, as described in Patent Document 1 has been proposed as a countermeasure for the low sensitivity region. The structure is referred to as an electrode overlaid type, which is expected as a structure for enhancing the sensitivity to the head output. In order to suppress the occurrence of the low sensitivity region, in this magnetoresistive magnetic head, an electrode is overlapped (overlaid) on a portion of the upper surface of the magnetoresistive device.

The magnetoresistive head described above is designed such that the sensing current supplied from the electrode flows in the central region with high sensitivity of the magnetoresistive film while avoiding the region at the end of the sensor of low sensitivity (low sensitivity region described above), which can prevent lowering of the head sensitivity. The magnetic head disclosed in the Patent Document 1 has a feature in view of the structure that a gap between a pair of electrodes is made smaller compared with the lateral size of the magnetoresistive device.

The electrode overlaid type magnetoresistive head involves significant problems with manufacturing although high sensitivity can be expected in view of its structure. That is, the size of the magnetoresistive device and the size of the inter-electrode gap have to be decided in separate processes (use of two photo-masks different from each other). Accordingly, the widths of the right and left overlaid regions vary within the range of the positioning accuracy in each of the processes. In a case where the positional accuracy is larger than the expected overlaid width, it is possible that the overlaid width becomes negative (not overlaid). Further, the inter-electrode distance defining the inner track width has to be made narrower compared with a not-overlaid structure (structure of joining usual hard magnetic layers), which is extremely disadvantageous in view of the process.

Further, Patent Document 2 discloses an invention as prior art regarding the method of manufacturing an electrode overlaid type magnetoresistive head. This invention provides a technique for reducing the variance of the overlaid widths, which discloses a technique capable of forming the width of the magnetoresistive device and the inter-electrode gap by a single mask, using a resist formed from one photo-mask, that is a self-alignment type manufacturing method.

Patent Document 1

Japanese Published Application No. 9-282618 (pages 7 and 8, and FIG. 1)

Patent Document 2

Japanese Published Application No. 2001-325703 (pages 5 to 7, and FIGS. 1 to 6)

FIG. 5(a) more schematically shows the electrode-overlaid structure shown in the prior art described above. Hard magnetic layers 51a, 51b are disposed on both ends of a magnetoresistive film 50, and electrode layers 52a, 52b are stacked on the hard magnetic layers 51a, 51b, respectively. Since the electrode layers 52a, 52b are disposed in a state of covering low sensitivity regions 53a, 53b, respectively, on both ends of the magnetoresistive film 50, current is more resistant to flow through the low sensitivity regions 53a, 53b and, as a result, the sensitivity is improved as the entire magnetoresistive film 50 (the range for the reduction of the sensitivity is suppressed).

However, the overlaid structure involves the following problems. One of them is a problem in view of the manufacturing process. The electrode layers 52a and 52b, and the hard magnetic layers 51a, 51b are formed by way of separate processes using separate masks. Thus, amounts of overlay of the electrode layers 52a, 52b depend on the alignment accuracy of an exposure apparatus such as a stepper. In usual exposure apparatus, production is conducted under the intended alignment accuracy at about 50 nm even in a preferred case and usually at about 100 nm for 3σ value. This is not a negligible size relative to the initial range of low sensitivity region. Then, a process for mass production with good yield for industrial products has been demanded.

A second problem is that since the electrode is in a state of positively riding over the magnetoresistive film, the gap enlarges in the direction of the film thickness between the upper and lower magnetic shields near the read back track ends. Since the enlargement of the magnetic shield gap lowers the shielding effect at positions near the ends of the read back track, signal magnetic fields from adjacent pits on a track identical with the signal magnetic field from the adjacent track tend to be read, which is effectively equivalent with the enlargement of the magnetic read back track width and with the enlargement of the read back gap length. Since improvement of the density in the direction of the track is essential to an improvement in recording density, lowering of the shield effect at positions near the end of the read back track is desirably as less as possible.

A third problem is that since the current shunt in the low sensitivity region of the magnetic resistive film cannot be reduced to zero by the electrode overlay, the current shunt to the low sensitivity region is again not negligible as the track width is further narrowed.

### SUMMARY OF THE INVENTION

A first object of the present invention is to provide a composite magnetic head having a magnetoresistive head free from the effect of the low sensitivity region caused at the end of the free layer, not undergoing the effect of the shunting loss of current and not resulting in reduction of the sensitivity.

A second object of the invention is to provide a composite magnetic head having a magnetoresistive head capable of suppressing the lowering of a magnetic shield effect at an end of a free layer.

A third object of the invention is to provide a composite magnetic head having a magnetoresistive head having a magnetic shield effect also in the transversal direction of a track.

A magnetoresistive head in a composite magnetic head according to the present invention for attaining the foregoing objects has a feature in eliminating a giant magnetoresistive effect (GMR effect) in an electrode-overlaid portion. The first method is to remove the anti-ferromagnetic layer in the electrode overlaid portion to reduce the thickness or remove a pinning layer. The second method is to reduce the thickness or remove the anti-ferromagnetic layer in the electrode overlaid portion thereby releasing the fixed magnetization direction in the pinning layer and enabling rotation of magnetization like the free layer. The third method is to impinge impurities into the anti-ferromagnetic layer in the electrode overlaid portion to eliminate a magnetic property.

According to the first method, since the pinning layer has no magnetic property, no GMR effect is generated at all. According to the second method, since the rotating operation of magnetization is identical between the pinning layer and the free layer, generation of a relative angle is suppressed and, as a result, the resistance change as the GMR effect is reduced to zero. The third method can provide the same effect as the first method. It is important that the free layer is left below the electrode overlay.

As described above, a structure free from the effects of the low sensitivity region at the track end can be provided but, since it is intended to avoid an increase in the element resistance by the constitution of the electrode on the outside, the electrode is desirably overlaid at the region eliminated with the GMR effect. In the constitution, since a track central portion with high sensitivity can be used selectively, a magnetic head with high sensitivity can be provided while keeping the thickness of the hard magnetic layer relatively thick as it is and lowering of the production yield due to variations in the film thickness of the hard magnetic layer can be prevent. While the current shunt to the low sensitivity region caused at the track end which was the drawback in the existent structure is still present, lowering of the sensitivity in the read back track region can be prevented basically by selectively making the low sensitivity region into an utterly insensitive region.

The process to the anti-ferromagnetic layer and the pinning layer can be conducted simultaneously when forming the magnetoresistive film by milling, and the electrode overlaid portion can be formed by re-utilizing the patterned resist used in this case. The hard magnetic layer and the main electrode layer on the outside thereof are also formed by using the same resist. The method is conducted specifically by the following steps.

The magnetoresistive film is patterned by etching particles with a predetermined angle relative to an axis vertical to the surface of the substrate. The method used preferably in this case is, for example, an IBE (Ion Beam Etching) with extremely intense directionality, in which a mechanism of allowing etching particles to enter slantly at a predetermined angle to the substrate and a mechanism of rotating and revolving a substrate itself are used in combination. The etching is applied about to such a depth that the pinning layer on the substrate planar surface is eliminated.

Then, an electrode material is deposited at a predetermined angle relative to the direction vertical to the substrate surface in the same manner. The film deposition method used preferably in this case is, for example, IBD (Ion Beam Deposition) with extremely intense directionality, in which a mechanism of allowing deposition particles to enter slantly at a predetermined angle to the substrate and a mechanism of rotating and revolving the substrate per se are used in combination. By making an angle upon BD, the resist formed in the initial stage is bulged in the transversal direction of the track. Then, a step of removing the unnecessary electrode material is applied while utilizing the bulging by use of IBE with intense directionality again. In this case, the incident direction of IBE is made vertical to the surface of the substrate. Since IBE has intense directionality, the portion located below the bulged resist forms a shadow, making it possible to leave the electrode material for the region at the end of the free layer.

Further, a hard magnetic layer and a main electrode layer are deposited from the state described above. The incident angle of particles is made vertical to the surface of the substrate. Lastly, remaining resist is removed by using a method referred to as lifting off.

As described above, patterning for the hard magnetic layer and the main electrode layer is conducted by a masking step for once. The masking step for once is to form a hard magnetic layer and a main electrode layer adjacent to a free layer based on the resist formed of one kind of photo-mask in which the hard magnetic layer and the main electrode layer are formed in a self alignment manner. This can manufacture the magnetoresistive head at high yield irrespective of the alignment accuracy of an exposure machine.

Further, since the thickness of the electrode overlaid portion can be decreased by removing the layer by so much as the thickness of the anti-ferromagnetic layer and the pinning layer, enlargement of the gap between the upper and lower magnetic shields at the end of the free layer can be suppressed to prevent lowering of the shield effect at the end of the free layer.

Further, when a soft magnetic layer such as made of permalloy is disposed between the hard magnetic layer and the main electrode layer, a shield effect can be provided at a portion in the vicinity in the traverse direction of the track of the magnetoresistive film (side shield). Since a signal magnetic field from the adjacent track is made less readable by the side shield layer, it can cope with a narrow track pitch while maintaining high sensitivity. The side shield layer can be spaced apart by a desired distance from a high sensitivity portion of the magnetoresistive film by the overlaid electrode and this can avoid the problem of lowering the sensitivity by the side shield layer. While the distance between the upper and lower magnetic shields is enlarged by the side shield layer and the main electrode layer, since the side shield layer is at a position nearer to the free layer than the upper and lower magnetic shields, the side shield effect gives larger effect. The main electrode layer may also be substituted with a soft magnetic layer such as made of permalloy or the like to function the layer also as the side shield layer.

### BRIEF DESCRIPTION OF THE DRAWINGS

FIG. 1 is a constitutional view of a magnetoresistive head, as viewed from a medium opposing surface, according to an embodiment of the present invention.

FIG. 2 is a perspective view of a composite magnetic head, as viewed from a medium opposing surface, according to an embodiment of the invention.

FIG. 3 is a process chart showing a method of manufacturing the magnetoresistive head according to the embodiment of the invention.

FIG. 4 is a process chart showing the method of manufacturing the magnetoresistive head according to the embodiment of the invention succeeding to FIG. 3.

FIG. 5 includes respective schematic views showing the effect of the magnetoresistive head according to the embodiment of the invention and that of a prior art for comparison with other.

The following table includes a description of reference numerals.

| | |
|---|---|
| 1 | Magnetoresistive head |
| 2 | Substrate |
| 3 | Lower magnetic shield |
| 4 | Magnetoresistive film |
| 5 | Upper magnetic shield |
| 6 | Separation layer |
| 7 | Inductive magnetic head |
| 8 | Lower magnetic layer |
| 9 | Upper magnetic layer |
| 10 | Conductive coil |
| 11 | Anti-ferromagnetic layer |
| 12 | Pinning layer |
| 13 | Protection layer |
| 14 | Free layer |
| 15 | Non-magnetic layer |
| 21a, 21b | Electrode overlaid layer (first electrode layer) |
| 22a, 22b | Hard magnetic layer (magnetic domain control layer) |
| 23a, 23b | Side shield |
| 24a, 24b | Main electrode layer (second electrode layer) |
| 26a, 26b | Crystal orientation control underlying layer |
| 27 | Lower gap layer |
| 28 | per gap layer |

### DESCRIPTION OF SPECIFIC EMBODIMENTS

Mode for Carrying Out the Invention

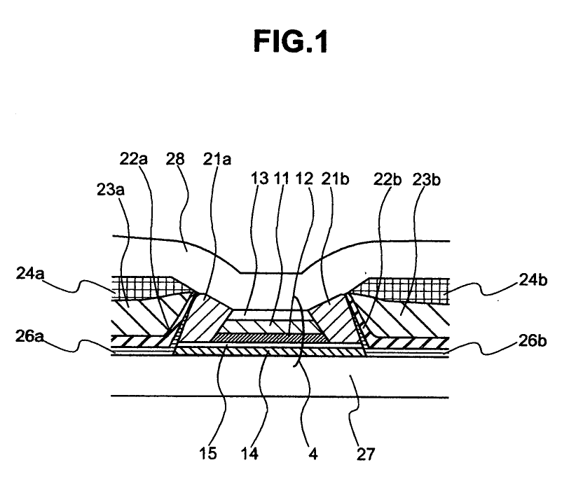

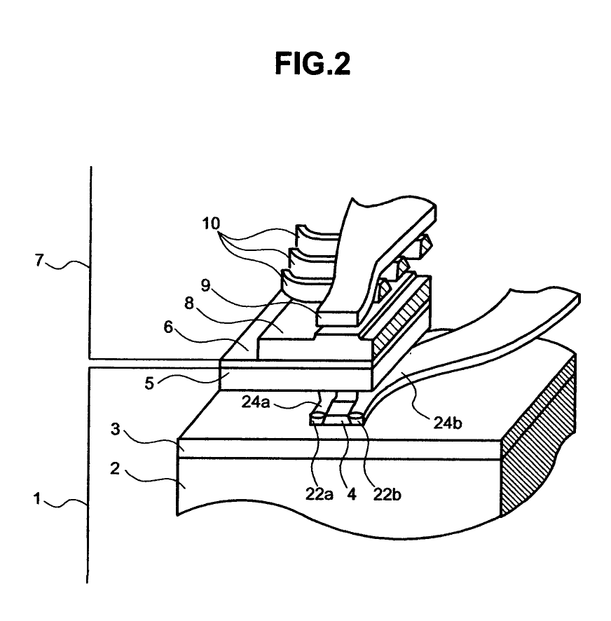

An embodiment of the present invention is to be described with reference to the drawings. FIG. 2 is a perspective view of a composite magnetic head as viewed from the flying surface. The composite magnetic head comprises a reading magnetoresistive head 1 and a recording inductive magnetic head 7. The magnetoresistive head 1 has a lower magnetic shield 3 formed on a substrate 2, a magnetoresistive film (spin-valve film) 4 formed thereon by way of a lower gap layer 27 (refer to FIG. 1), magnetic domain control layer (hard magnetic layer) 22a, 22b disposed respectively on both sides of the spin-valve film 4, electrode layer 24a, 24bs stacked thereon for supplying a sensing current to the spin-valve film 4 and an upper magnetic shield 5 formed thereon by way of an upper gap layer 28 (refer to FIG. 1).

The inductive magnetic head 7 has a lower magnetic layer 8 formed on the magnetoresistive head 1 by way of an insulative separation layer 6, an upper magnetic layer 9 forming a magnetic gap on the side of the flying surface in cooperation with the lower magnetic layer 8 and connected at a rear portion thereof with the lower magnetic layer 8 to form a magnetic circuit, and conductive coils 10 formed between the lower magnetic layer 8 and the upper magnetic layer 9 by way of an insulation layer (not illustrated).

Then, a description will be made of the structure of magnetoresistive head 1 having high sensitivity and stable structure according to an embodiment of the invention. FIG. 1 is a view of the magnetoresistive head 1 as viewed from a medium opposing surface. In particular, FIG. 1 shows a structure in which an anti-ferromagnetic film 11 is disposed to an upper portion, which is generally referred to also as a top spin-valve head. The magnetoresistive head 1 is constituted by stacking a free layer 14 made of a ferromagnetic layer at the lowermost surface, and stacking thereon, an inter-layer bonding layer 15 made of a non-magnetic conductive material such as made of Cu, a pinning layer 12 made of a ferromagnetic layer and, further, an anti-ferromagnetic layer 11 such as made of PtMn, and a protective film 13 at the uppermost surface for protecting the films described above.

FIG. 1 shows a 5-layered structure, since it adopts the minimum film constitution but it may be also sometimes designed such that a crystal control layer is disposed under the free layer 14, oxide layers are disposed above and below the free layer 14 or the pining layer 12 for enhancing the spin-valve effect, another magnetic layer is stacked or a low resistance film such as made of Cu is disposed below the free layer 14 for controlling the center of biasing current in the direction of the film thickness. Further, the spin-valve structure also includes a bottom spin-valve structure in which the anti-ferromagnetic layer is disposed below and, further, a dual spin-valve structure in which anti-ferromagnetic layers are disposed by two upper and lower layers.

The stacked films 4 are patterned in the transversal direction of the track while leaving the inter-layer bonding layer 15 and lower layers, and electrode overlaid layers 21a, 21b are formed on both sides thereof by using a highly conductive electrode layer material, for example, a material made of Au, Ta, W, Ru, Rh, Cu, Ti, Ag, Pt, Pd, Cr, In, Ir, Nb or Zr, or an alloy material or a mixed material containing one or more of the elements describe above. The conductive layers are respectively constituted so as to cover the respective ends of the ferromagnetic layer 11 and the spinning layer 12 in the magnetoresistive film 4 and, further, disposed so as to make the distance between adjacent magnet domain control layers (hard magnetic layer) 22a, 22b to a certain size. The electrode overlaid layers 21a, 21b functions to form an insensitive region width not having the GMR effect. Crystal orientation control underlying layers 26a, 26b are disposed with an aim of improving the magnetic characteristics of the hard magnetic layers 22a, 22b.

Non-magnetic Cr, Ti, W or the like is used for the crystal orientation control underlying layers 26a, 26b and the crystal orientation control underlying films 26a, 26b are disposed so as to align the crystal orientation of the hard magnetic layers 22a, 22b stacked to the upper layer thereby strengthening the in-plane anisotropy. Further, since they weaken the exchange coupling between the hard magnetic layers 22a, 22b and the magnetoresistive film 4, it is required that the crystal orientation control underlying layers 26a, 26b are formed as thin as possible and they are prepared within a range of about 5 nm or less. The crystal orientation control underlying layers 26a, 26b are sometimes not deposited depending on the structure.

Soft magnetic layers are disposed as side shield layers 23a, 23b on the hard magnetic layers 22a, 22b, respectively. However, when they are deposited directly, magnetization of the soft magnetic layers 23a, 23b direct in the direction identical with that of the magnetization of the hard magnetic layers 22a, 22b by the intense exchange coupling to the hard magnetic layers 22a, 22b, possibly increasing the bias field in the longitudinal direction to the magnetoresistive film 4 to possibly lower the sensitivity.

Although not illustrated, to avoid this problem, it is desirable to sandwich a material of a predetermined thickness, for example, Au, Ta, W, Ru, Rh, Cu, Ti, Ag, Pt, Pd, Cr, In, Ir, Nb or Zr between the hard magnetic layers 22a, 22b and the soft magnetic layers 23a and 23b, respectively, such that the magnetization direction are in a counter-parallel manner between the side shield layers 23a, 23b and the hard magnetic layers 22a, 22b, respectively. Main electrodes 24a, 24b that function to provide a current bias to the magnetoresistive film 4 and supply a sensing current for detecting the resistance change caused in the magnetoresistive film 4 on the side shield layers 23a, 23b.

Further, the films described above are sandwiched between a lower gap layer 27 and an upper gap layer 28 disposed with an aim of electric insulation. A highly-insulating and hard material such as alumina is used for the lower and the upper gap layer. Lower and upper magnetic shields 3, 5 (refer to FIG. 2), for example, comprising soft magnetic layers such as made of a permalloy are disposed further on the outside of the lower and upper gap layers 27, 28, respectively (refer to FIG. 2).

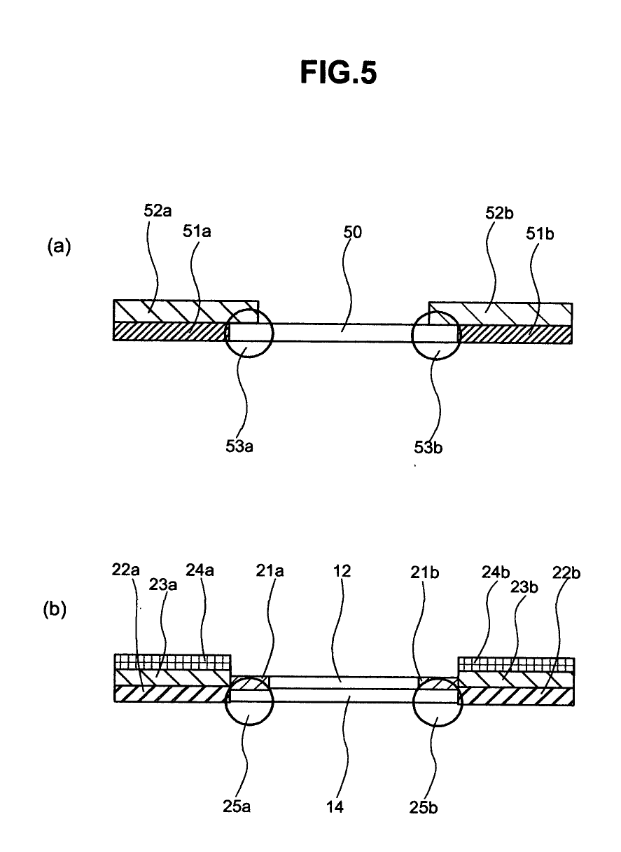

The low sensitivity region of the high sensitivity and stable spin-valve head 1 according to the embodiment of the invention is to be described with reference to FIG. 5(b). FIG. 5(b) is a schematic view of a spin-valve head 1 as viewed from a medium-opposing surface. The structure has a feature in that predetermined distances 25a and 25b are respectively formed between the hard magnetic layers 22a, 22b and the pinning layer 12. Since the portions 25a and 25b consist only of the free layer 14, they do not cause the GMR effect and form an insensitive region, which causes no low sensitivity region as in FIG. 5(a).

Accordingly, a constitution of not using the lower sensitivity portion at the end of the free layer 14 can be provided. The side shield layers 23a, 23b are respectively disposed between the main electrode layer 24a and the hard magnetic layer 22a and between the main electrode layer 24b and the hard magnetic layer 22b, thereby providing an effect of shielding signal magnetic fields from the transversal direction such as from adjacent tracks.

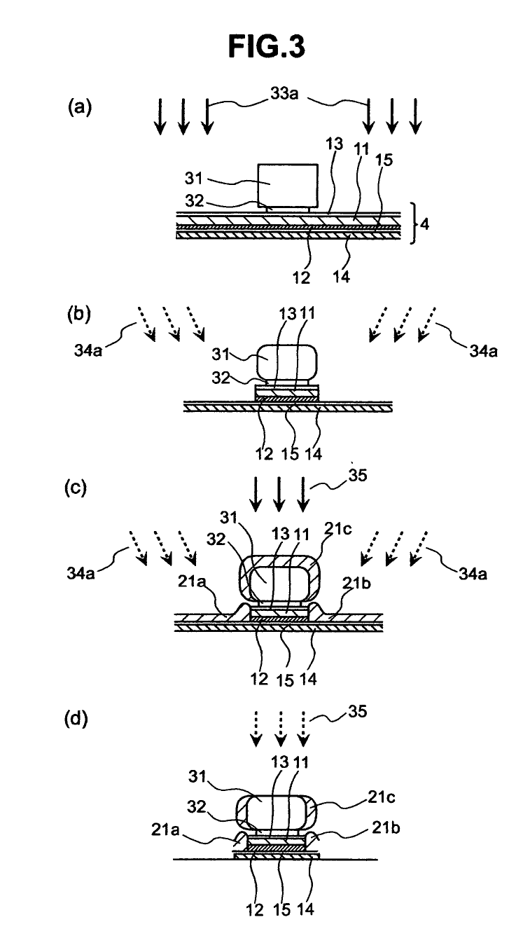

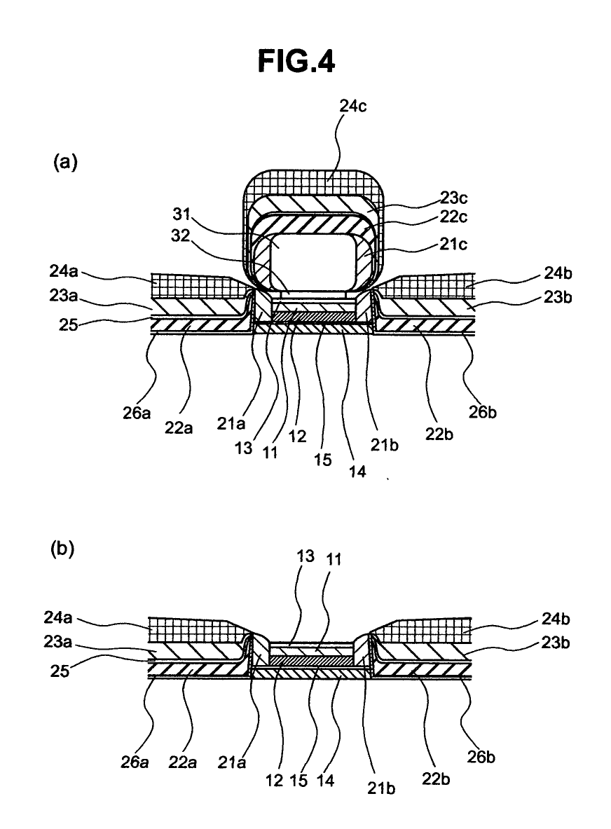

Then, a description will be made of the manufacturing process of a highly sensitive and stable spin-valve head 1 according to the embodiment of the invention described above while referring to FIGS. 3(a) to 3(d), 4(a) and 4(b). A process as viewed from the medium opposing surface is disclosed. At first, as shown in FIG. 3(a), the magnetoresistive film 4 is deposited on the substrate 2 (refer to FIG. 2). The layers stacked from the free layer 14 as the lowermost layer and then, successively, the inter-layer bonding layer 15, the pinning layer 12, the anti-ferromagnetic layer 12 and the protection layer 13.

Resists 32 and 31 are formed in order to pattern the magnetoresistive film 4 deposited on the substrate to the width of the reading track. The resists 32 and 31 are formed by depositing a mask of a predetermined shape on the resist, then applying exposure to the resist by use of an exposure machine and applying development to the resist. In this case, the resist is formed in a dual layer structure and in such a shape that the width of the resist 32 in the lower layer is smaller than that of the resist 31 in the upper layer by utilizing the nature that the development processing rates of the respective layers are different from each other. This is a treatment for facilitating the process of finally removing the resists 32 and 31 (lift off process). The resist may optionally be a resist of a single layer. While a rectangular shape is illustrated for the resists 32 and 31, a trapezoidal shape or an inverted trapezoidal shape can also be selected.

The thus formed resists 32 and 31 as the mask are irradiated from above with etching particles 33a to remove the regions other than the resist mask. For the etching, it is desirable to use IBE (Ion Beam Etching) capable of preparing etching particles at high directionality. What is important in this step is that etching is completed within a range of the pinning layer 12 or the Cu layer 15. This is because magnetization of the pinning layer 12 below the ferromagnetic material should possibly be fixed if the anti-ferromagnetic material is left. However, when the fixing for magnetization of the pinning layer 12 can be eliminated by reducing the thickness of the anti-ferromagnetic layer 11 to some extent, the etching may be stopped at that position. The following description is to be made in a case of etching as far as the pinning layer 12.

It is desirable that the etched end of the magnetoresistive film 4 is as vertical as possible, and the angle of etching is set vertical to the surface of the substrate so as to attain the state.

FIG. 3(b) shows a magnetoresistive device formed as described above. Then, to deposit conductive layers 21a, 21b as the electrode overlaid portions, a conductive material is deposited. Au is used in this case for the conductive material. For deposition particles, IBD (Ion Beam Deposition) capable of forming particles with high directionality is preferred. In IBD, it is possible to prepare Au particles 34a at high directionality by exposing an Au target to an ion beam source of high directionality. Films are deposited so as to cover the ends of the patterned magnetoresistive device by using rotation and revolution in combination while slanting the substrate.

In this case, as shown in FIG. 3(c), Au particles 21c are also deposited to the remaining resist 31. As a result, a resist (with Au) can be formed which is extended in the transversal direction of the track by so much as the deposition of Au film relative to the initial width. The Au conductive layer is deposited so as to cover the upper portion at the end of the magnetoresistive film outside from the end of the pinning layer 12.

Then, a description will be made of a process of removing unnecessary conductive film, the cu layer 15 and the free layer 14 outside the electrode overlaid portions 21a, 21b. Etching particles by IBE are used in the same manner as described above for the removal of the conductive film. They are emitted vertically to the substrate as shown at 35. Thus, the conductive film, the Cu layer 15 and the free layer 14 can be removed while leaving only the portion as a shadow of Au 21c deposited to the lateral sides of the resist. The thickness of the Au 21c on the lateral side of the resist corresponds to the electrode overlay width. The result is shown in FIG. 3(d).

FIG. 3(d) depicts a form in which portions on the left of the conductive layer 21d and on the right of the conductive layer 21b are completely removed as far as the free layer 14, but it is actually difficult to completely remove the entire region in the plane of the substrate uniformly. Depending on the case, a form in which alumina is etched (over-etching) causes no practical problem.

Then, as shown in FIG. 4(a), crystal orientation underlying layers 26a, 26b as the hard magnetic layer, as well as hard magnetic layers 22a, 22b, an intermediate layer 25, side shield layers 23a, 23b and main electrode layers 24a, 24b are deposited. The angle of irradiation of deposition particles is set so as to be vertical to the surface of the substrate. Thus, the side shield layers 23a, 23b can be formed while placing the hard magnetic layers 22a and 22b on the sides of the free layer 14 and performing magnetic domain control on the free layer 14.

Successively, as shown in FIG. 4(b), the resists 32, 31 are removed by a lift-off method to complete a series of processing for manufacturing the magnetoresistive device. As described in FIG. 1, the lower gap layer 27 and the upper gap layer 28 are formed above and below the magnetoresistive device and, as shown in FIG. 2, the lower magnetic shield 3 and the upper magnetic shield 5 are further formed on the outside thereof.

In the foregoing descriptions, although a method of reducing the thickness or removing the anti-ferromagnetic layer 11, or removing the anti-ferromagnetic layer 11 and reducing the thickness or removing the pinning layer 12 for eliminating the fixing of magnetization of the pinning layer 12 has been described, impurities may be implanted into the anti-ferromagnetic layer for eliminating the magnetic property of the anti-ferromagnetic layer at the electrode overlaid portions.

Further, while the side shield layers 23a, 23b are respectively disposed between the hard magnetic layer 22a and the main electrode layer 24a and between the hard magnetic layer 22b and the main electrode layer 24b, they are not necessarily disposed if there is no problem for the effect from adjacent tracks.

Further, while the structure of depositing the crystal orientation underlying layers 26a, 26b for the hard magnetic layers 22a, 22b, respectively, are shown, the crystal orientation underlying layers 26a, 26b can be saved if the magnetic characteristic of the hard magnetic layers 22a, 22b can satisfy the intended specification.

According to the embodiment described above, a remarkable effect can be provided when the track width is narrowed to 100 nm or less and the electrode overlaid region is reduced to 20 nm or less, obtaining a highly sensitive magnetoresistive head at high production yield. Further, while it is necessary to narrow the width between the upper and lower magnetic shields and the distance relative to the side shield layer in order to improve the reading resolution along with increasing density in the magnetic recording technique, the embodiment can provide a structure and a manufacturing method that can easily cope with increasing density.

As apparent from the detailed descriptions above, the embodiment of the present invention provides the structure in which the width of the anti-ferromagnetic layer and/or pinning layer is narrow relative to the free layer of the magnetoresistive film. Thus, this structure does not use the low sensitivity region on both ends of the free layer and, as a result, this can provide a magnetoresistive head capable of detecting magnetic signals from the media at higher sensitivity compared with existent structures.

Further, since the low sensitivity region on both ends of the free layer can be made into the insensitive region, the embodiment of the invention can provide a structure capable of basically solving the disadvantage caused by current shunting to the low sensitivity region.

Further, the embodiment of the invention can provide a structure in which the side shield layer can be disposed at a certain distance from the electrode overlaid portion at the end of the magnetoresistive film. Accordingly, the embodiment can provide an excellent magnetoresistive head not reading adjacent track signals even in a case of improving the track density.

Further, since the embodiment of the invention can provide a structure of not causing misalignment in the deposition of the electrode overlay and the hard magnetic layer, the distance between the side shield layer and the magnetoresistive film can be stabilized.

Further, the embodiment of the invention can provide a method of manufacturing a magnetoresistive head not causing misalignment for deposition of the electrode overlay and the hard magnetic layer.

Further, since the embodiment of the invention can provide a structure of not causing misalignment upon overlapping of the hard magnetic layer and the main electrode layer, it is possible to provide a method of manufacturing a magnetoresistive head capable of drastically improving the manufacturing yield and improving the productivity.

While the embodiment and the modified examples described above are applied to the top spin-valve structure, the invention is applicable also to a bottom spin-valve structure, a dual spin-valve structure and a TMR (Tunneling Magnetoresistive) head in which a free layer and a pinning layer are disposed sandwiching an insulative barrier layer therebetween and electrode layers are disposed above and below the stack of layers.

The present invention can provide a composite magnetic head having a magnetoresistive head free from the effect of a low sensitivity region formed at the ends of a free layer, and the effect of loss of shunting current and not lowering the sensitivity.

What is claimed is:

1. A composite magnetic head comprising:
a magnetoresistive head comprising:
a lower magnetic shield disposed on a substrate;
a lower gap layer;
a first ferromagnetic layer;
a non-magnetic layer;
a second ferromagnetic layer;
an anti-ferromagnetic layer having non-magnetic regions on both the ends thereof;
first electrode layers disposed respectively on the non-magnetic regions of the anti-ferromagnetic layer;
magnetic domain control layers disposed respectively on the ends of a stack of layers consisting of the lower magnetic shield, the lower gap layer, the first ferromagnetic layer, the non-magnetic layer, the second ferromagnetic layer, the anti-ferromagnetic layer, and the first electrode layers;
second electrode layers disposed respectively on the magnetic domain control layers; and
an upper magnetic shield disposed on the second electrode layers and the stack of layers by way of an upper gap layer; and
an inductive magnetic head disposed on the magnetoresistive head by way of an insulation layer.

2. A composite magnetic head as defined in claim 1, wherein the non-magnetic region of the anti-ferromagnetic layer is formed by implanting impurities into the anti-ferromagnetic material.

3. A composite magnetic head as defined in claim 1, wherein a width of the first electrode layer is 20 nm or less.

4. A composite magnetic head as defined in claim 1, wherein the first and the second electrode layer contain one or more of elements of at least Au, Ta, W, Ru, Rh, Cu, Ti, Ag, Pt, Pd, Cr, In, Ir, Nb and Zr.

5. A composite magnetic head as defined in claim 1, wherein a soft magnetic layer is disposed between the domain control layer and the second electrode layer.

6. A composite magnetic head as defined in claim 1, wherein a crystal orientation underlying layer is disposed below the magnetic domain control layer.

7. A composite magnetic head comprising:
a magnetoresistive head comprising:
a lower magnetic shield disposed on a substrate;
a lower gap layer;
a first ferromagnetic layer;
a non-magnetic layer;
a second ferromagnetic layer;
an anti-ferromagnetic layer having both ends whose width is narrower than that of the second ferromagnetic layer;
first electrode layers disposed on the second ferromagnetic layer at both the ends of the anti-ferromagnetic layer;
magnetic domain control layers disposed respectively on the ends of a stack of layers consisting of the lower magnetic shield, the lower gap layer, the first ferromagnetic layer, the non-magnetic layer, the second ferromagnetic layer, the anti-ferromagnetic layer, and the first electrode layers;
second electrode layers disposed respectively on the magnetic domain control layers; and
an upper magnetic shield disposed on the second electrode layers and the stack of layers by way of an upper gap layer; and
an inductive magnetic head disposed on the magnetoresistive head by way of an insulation layer.

8. A composite magnetic head as defined in claim 7, wherein a width of the first electrode layer is 20 nm or less.

9. A composite magnetic head as defined in claim 7, wherein the first and the second electrode layer contain one or more of elements of at least Au, Ta, W, Ru, Rh, Cu, Ti, Ag, Pt, Pd, Cr, In, Ir, Nb and Zr.

10. A composite magnetic head as defined in claim 7, wherein a soft magnetic layer is disposed between the domain control layer and the second electrode layer.

11. A composite magnetic head as defined in claim 7, wherein a crystal orientation underlying layer is disposed below the magnetic domain control layer.

12. A composite magnetic head comprising:
a magnetoresistive head comprising:
a lower magnetic shield disposed on a substrate;
a lower gap layer;
a first ferromagnetic layer;
a non-magnetic layer;
a second ferromagnetic layer;
an anti-ferromagnetic layer disposed on a central portion other than both ends of the second magnetic layer;
first electrode layers disposed respectively on both ends of the second ferromagnetic layer;
magnetic domain control layers disposed respectively on the ends of a stack of layers consisting of the lower magnetic shield, the lower gap layer, the first ferromagnetic layer, the non-magnetic layer, the second ferromagnetic layer, the anti-ferromagnetic layer, and the first electrode layers;
second electrode layers disposed respectively on the magnetic domain control layers; and
an upper magnetic shield disposed on the second electrode layers and the stack of layers by way of an upper gap layer; and
an inductive magnetic head disposed on the magnetoresistive head by way of an insulation layer.

13. A composite magnetic head as defined in claim 12, wherein a width of the first electrode layer is 20 nm or less.

14. A composite magnetic head as defined in claim 12, wherein the first and the second electrode layer contain one or more of elements of at least Au, Ta, W, Ru, Rh, Cu, Ti, Ag, Pt, Pd, Cr, In, Ir, Nb and Zr.

15. A composite magnetic head as defined in claim 12, wherein a soft magnetic layer is disposed between the domain control layer and the second electrode layer.

16. A composite magnetic head as defined in claim 12, wherein a crystal orientation underlying layer is disposed below the magnetic domain control layer.
